(19) United States
(12) Patent Application Publication
(10) Pub. No.: US 2012/0179458 A1
(43) Pub. Date: Jul. 12, 2012

(54) APPARATUS AND METHOD FOR ESTIMATING NOISE BY NOISE REGION DISCRIMINATION

(76) Inventors: Kwang-Cheol Oh, Yongin-si (KR); Jeong-Su Kim, Yongin-si (KR); Jae-Hoon Jeong, Yongin-si (KR); So-Young Jeong, Seoul (KR)

(21) Appl. No.: 13/286,369

(22) Filed: Nov. 1, 2011

(30) Foreign Application Priority Data
Jan. 7, 2011 (KR) 10-2011-0001852

(51) Int. Cl. G10L 21/02

(52) U.S. Cl. 704/203; 704/205

(57) ABSTRACT

Provided are an apparatus and method for estimating noise that changes with time. The apparatus may calculate a speech absence probability that indicates the possibility of the absence of speech in each frequency component of an input acoustic signal, may discriminate between a speech-dominant region and a noise region from the acoustic signals based on the speech absence probability, and may estimate noise according to the discrimination result.

### CROSS-REFERENCE TO RELATED APPLICATION(S)

This application claims the benefit under 35 U.S.C. §119(a) of Korean Patent Application No. 10-2011-0001852, filed on Jan. 7, 2011, in the Korean Intellectual Property Office, the entire disclosure of which is incorporated herein by reference for all purposes.

### BACKGROUND

1. Field

The following description relates to an apparatus and a method for processing an acoustic signal, and additionally, to an apparatus and method for accurately estimating noise that changes with time.

2. Description of the Related Art

During a voice call made with a communication terminal such as a mobile phone, noises or ambient sound may make it difficult to ensure the quality of sound. Therefore, to improve speech quality in a situation in which noises are present, various technologies may be used to detect surrounding noise components and extract only target voice signals.

In addition, various terminals such as, for example, a camcorder, a notebook PC, a navigation, a game controller, a tablet, and the like, may increase in the use of voice application technologies because they can operate in response to voice input or to stored audio data. Accordingly, a technique for extracting good quality of speech signals is desirable.

Various methods for detecting and/or removing ambient noises have been suggested. However, if statistical characteristics of noises change with time, or if unexpected sporadic noises occur in an early stage of observing the statistical characteristics of noises, a desired noise reduction performance may be difficult to achieve using conventional methods.

### SUMMARY

In one general aspect, there is provided a noise estimation apparatus including an acoustic signal input unit comprising two or more microphones, a frequency transformation unit configured to transform acoustic signals input from the acoustic signal input unit into acoustic signals in a frequency domain, a phase difference calculation unit configured to calculate a phase difference of each frequency component from the transformed acoustic signals in the frequency domain, a speech absence probability calculation unit configured to calculate a speech absence probability that indicates the possibility of the absence of speech in each frequency component according to time, using the calculated phase difference, and a noise estimation unit configured to discriminate a speech-dominant region or a noise region from the acoustic signals, based on the speech absence probability, and to estimate noise according to the discrimination result.

The speech absence probability calculation unit may be further configured to extract an intermediate parameter that indicates whether the phase difference of each frequency component is within a target sound allowable range that is determined based on a target sound direction angle, and to calculate the speech absence probability of each frequency component using the intermediate parameter for peripheral frequency components of each frequency component.

The speech absence probability calculation unit may be configured to allocate the intermediate parameter as ‘0’ if the phase difference of each frequency component is within the target sound phase difference allowable range, and otherwise to allocate the intermediate parameter as ‘1.’

The speech absence probability calculation unit may be further configured to add intermediate parameters of peripheral frequency components of each frequency component, normalize the added values, and calculate the speech absence probability of each frequency component.

The noise estimation unit may be further configured to determine, with respect to the acoustic signals in a frequency domain, a region in which the calculated speech absence probability is greater than a threshold value as a noise region, and to determine a region in which the calculated speech absence probability is smaller than the threshold value as a speech-dominant region.

The noise estimation unit may be further configured to estimate noise by tracking local minima on a frequency axis with respect to spectrum of a frame of an acoustic signal that corresponds to the speech-dominant region.

In one example, a time index is t, a frequency index is k, and a spectral magnitude of an input acoustic signal is Y(k,t), the noise estimation-unit may be further configured to track local minima on a frequency axis by determining that the spectral magnitude Y(k,t) is likely to contain speech and allocating noise Λ(k,t), which is estimated by tracking local minima at a frequency index k, as a value between Λ(k−1,t), which is estimated by tracking local minima at a frequency index k−1, and the spectral magnitude Y(k,t) when the spectral magnitude Y(k,t) is greater than noise Λ(k−1,t), and by allocating noise Λ(k,t) as a value of the spectral magnitude Y(k,t) when the spectral magnitude Y(k,t) is not greater than the noise Λ(k−1,t).

The noise estimation unit may be further configured to smooth the estimated noise using the calculated speech absence probability.

The noise estimation unit may be further configured to use noise \hat{Λ}(k, t−1) that has been estimated by tracking local minima and been smoothed using a speech absence probability at a previous time index t−1, noise Λ(k,t) that is tracked by local minima at a time index t, and the speech absence probability P(k,t) at a frequency index k and a time index t as a smoothing parameter for \hat{Λ}(k, t−1) and Λ(k,t), to determine smoothed noise \hat{Λ}(k, t) by smoothing the noise Λ(k,t) using the speech absence probability P(k,t), and to estimate the smoothed noise \hat{Λ}(k, t) as final noise.

The noise estimation unit may be further configured to estimate the noise from a spectral magnitude that results from transforming an acoustic signal in a frequency domain that is input in the noise region.

In another aspect, there is provided a noise estimation method including transforming acoustic signals input from two or more microphones into acoustic signals in a frequency domain, calculating a phase difference of each frequency component from the transformed acoustic signals in a frequency domain, calculating a speech absence probability that indicates the possibility of the absence of speech in each frequency component according to time based on the calculated phase difference, and discriminating a speech-dominant region and a noise dominant region from the acoustic signals based on the speech absence probability and estimating noise based on the discrimination result.

The calculating of the speech absence probability may comprise extracting an intermediate parameter that indicates whether the phase difference of each frequency component is within a target sound allowable range that is determined based on a target sound direction angle, and calculating the speech absence probability of each frequency component using the intermediate parameter for peripheral frequency components of each frequency component.

The extracting of the intermediate parameter may comprise allocating the intermediate parameter as ‘0’ if the phase difference of each frequency component is within the target sound phase difference allowable range, and otherwise allocating the intermediate parameter as ‘1.’

The calculating of the speech absence probability using the extracted intermediate parameter may comprise adding intermediate parameters of peripheral frequency components of each frequency component, and normalizing the added value to calculate a speech absence probability of each frequency component.

The estimating of the noise may comprise determining, with respect to the acoustic signals in a frequency domain, a region in which the calculated speech absence probability is greater than a threshold value as a noise region, and determining a region in which the calculated speech absence probability is smaller than the threshold value as a speech-dominant region.

The estimating of the noise may comprise estimating noise by tracking local minima on a frequency axis with respect to spectrum of a frame of an acoustic signal which corresponds to the speech-dominant region, and smoothing the estimated noise using the calculated speech absence probability.

The estimating of the noise may comprise estimating the noise from a spectral magnitude which results from transforming an acoustic signal in a frequency domain that is input in the noise region.

In another aspect, there is provided a noise estimation apparatus for estimating noise in acoustic signals in a frequency domain, the noise estimation apparatus including a speech absence probability unit configured to calculate a speech absence probability indicating the probability that speech exists in each frame of an acoustic signal, and a noise estimation unit configured to distinguish between a speech-dominant frame and a noise dominant frame based on the calculated speech absence probability, to estimate noise for a speech-dominant frame using a first method in the frequency domain, and to estimate noise for a noise-dominant frame using a second method in the frequency domain.

The first method may comprise estimating noise in the speech-dominant frame by tracking local minima on a frequency axis, and the second method may comprise estimating noise in the noise-dominant frame using a spectral magnitude of the acoustic signal that is obtained by performing a Fourier transform on the acoustic signal.

The first method may further comprise smoothing noise that has been estimated by tracking local minima based on the calculated speech absence probability, to reduce the occurrence of inconsistency in a noise spectrum on the boundary between the noise-dominant region and the speech-dominant region.

The noise estimation apparatus may further comprise a frequency transformation unit configured to transform a plurality of acoustic signals in a time domain, into a plurality of acoustic signals in the frequency domain, and a phase difference calculation unit configured to calculate a phase difference of each frequency component from the transformed acoustic signals in a frequency domain.

The speech absence probability unit may calculate the speech absence probability based on a phase difference between the plurality of acoustic signals in the frequency domain.

The speech absence probability unit may calculate the speech absence probability based on an intermediate parameter that is set by comparing the phase difference of each frequency component to a threshold value.

The noise estimation apparatus may further comprise a noise removal unit configured to remove the noise estimated by the noise estimation unit from the acoustic signal in the frequency domain.

Other features and aspects may be apparent from the following detailed description, the drawings, and the claims.

### BRIEF DESCRIPTION OF THE DRAWINGS

FIG. 1 is a diagram illustrating an example of an apparatus for estimating noise in an acoustic signal.

FIG. 2 is a diagram illustrating an example of a method for calculating a phase difference between acoustic signals.

FIG. 3 is a diagram illustrating an example of a target sound phase difference allowable range according to a frequency detected.

FIG. 4 is a diagram illustrating an example of a noise estimation unit shown in FIG. 1.

FIG. 5 is a graph illustrating an example of a noise level tracking result that is based on local minima in a speech-dominant region.

FIG. 6 is a flowchart illustrating an example of a method for estimating noise according to discrimination of a speech-dominant region and a noise region.

FIG. 7 is a flowchart illustrating an example of a method for estimating, noise of an acoustic signal.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

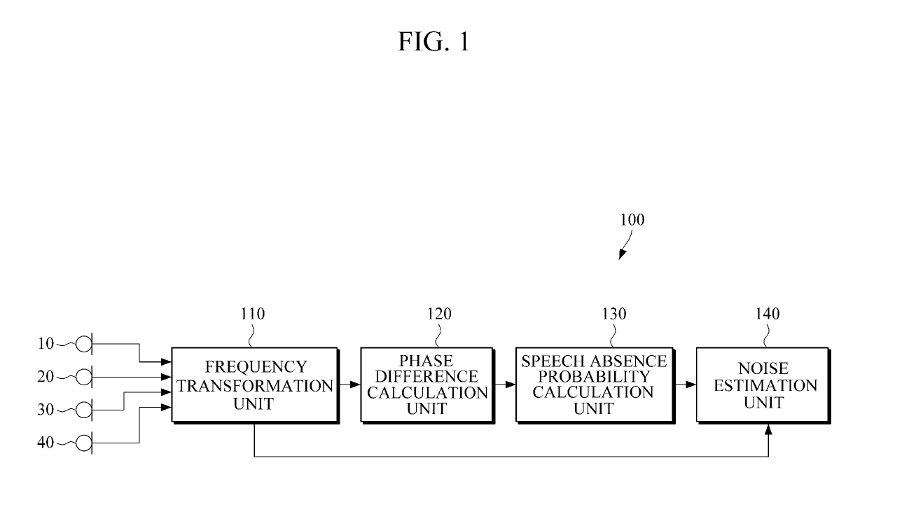

FIG. 1 illustrates an example of an apparatus for estimating noise in an acoustic signal.

Referring to FIG. 1, apparatus 100 includes a microphone array that has a plurality of microphones 10, 20, 30, and 40, a frequency transformation unit 110, a phase difference calculation unit 120, a speech absence probability calculation unit 130, and a noise estimation unit 140. For example, the apparatus 100 may be implemented in various electronic devices such as a personal computer, a notebook computer, a handheld or laptop device, a headset, a hearing aid, a mobile terminal, a smart phone, a camera, an MP3 player, a tablet, a home appliance, a microphone-based sound input device for voice call and recognition, and the like.

The microphone array may have a plurality of microphones, for example, four microphones 10, 20, 30, and 40, and each microphone may include an acoustic amplifier, an analog/digital converter, and the like, which may be used to transform an input acoustic signal into an electrical signal. Although the apparatus 100 shown in FIG. 1 includes four microphones 10, 20, 30, and 40, the number of microphones is not limited thereto. For example, the number of microphones may be three or more.

The microphones 10, 20, 30, and 40 may be placed on the same surface of the apparatus 100. For example, microphones 10, 20, 30, and 40 may be arranged on a front surface or on a side surface of the apparatus 100.

The frequency transformation unit 110 may receive an acoustic signal in a time domain from each of the microphones 10, 20, 30, and 40. The frequency transformation unit 110 may transform the acoustic signals into acoustic signals in a frequency domain. For example, the frequency transformation unit 110 may transform an acoustic signal in a time domain into an acoustic signal in a frequency domain using a discrete Fourier transform (DFT) or fast Fourier transform (FFT).

The frequency transformation unit 110 may divide an input acoustic signal into frames, and transform the acoustic signal into an acoustic signal in a frequency domain on a frame-by-frame basis. For example, the unit of a frame may be determined according to a sampling frequency, a type of an application, and the like.

The phase difference calculation unit 120 may calculate a phase difference of a frequency component from a frequency input signal. For example, the phase difference calculation unit 120 may extract phase components of each frequency on a frame-by-frame basis for signals x₁(t) and x₂(t) that are input on a frame-by-frame basis, and may calculate a phase difference. The phase difference of each frequency component may refer to a difference between frequency phase components which are calculated in an analysis frame of each channel.

From among the first channel input signals that are generated by converting a frequency of input signals from the first microphone 10, an input signal X₁(n, m) that is the mth input signal in the nth frame may be represented by Equation 1. In this example, a phase value may be represented by Equation 2. A signal which is generated by converting the frequency of another input signal X₂(n, m) from a different microphone, for example, the second microphone 20 may be represented in the same manner as the input signal X₁(n, m).

$$\begin{matrix}{X}_{1} ( n , m ) = a + jb & ( 1 ) \\ ∠ {X}_{1} ( n , m ) = {tan}^{- 1} \frac{b}{a} & ( 2 )\end{matrix}$$

In this example, a phase difference between the input signal X₁(n, m) and the input signal X₂(n, m), which have had their frequencies converted, may be calculated using a difference between ∠X₁(n,m) and ∠X₂(n,m).

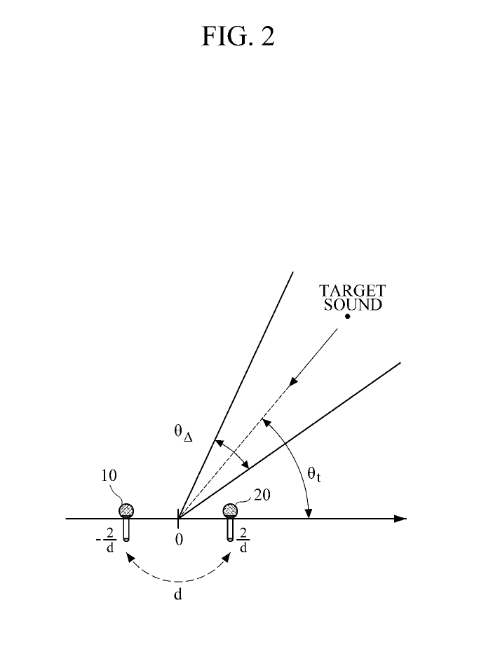

A method for calculating a phase difference of each frequency component is described with reference to FIG. 2. For example, if acoustic signals are input from four microphones 10, 20, 30, and 40, as shown in FIG. 1, the phase difference calculation unit 120 may calculate three phase differences. An average of the calculated phase differences may be used to calculate a speech absence probability.

The speech absence probability calculation unit 130 may calculate a probability that speech is absent in a frequency component according to time. The speech absence probability may be calculated from a phase difference. In this example, the value of the speech absence probability may represent the probability that speech does not exist at a specific time or at a specific frequency component.

The speech absence probability calculation unit 130 may extract an intermediate parameter that indicates whether a phase difference of each frequency component is within a target sound phase difference allowable range. The intermediate parameter may be determined based on a target sound direction angle. The speech absence probability calculation unit 130 may calculate the speech absence probability of each frequency component using the intermediate parameter for peripheral frequency components of each frequency component.

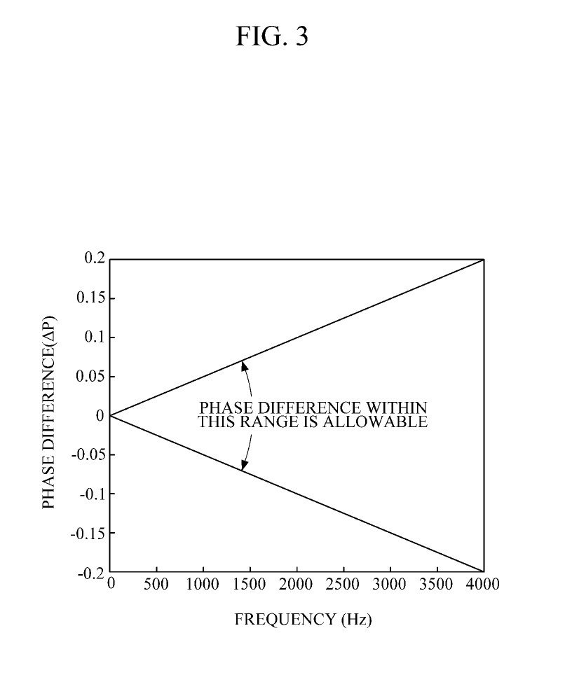

As an example, if the phase difference of frequency component is within the target sound phase difference allowable range, the speech absence probability calculation unit 130 may allocate 0 as an intermediate parameter. As another example, if the phase difference of frequency component is not within the target sound phase difference allowable range, the speech absence probability calculation unit 130 may allocate 1 as the intermediate parameter. The speech absence probability calculation unit 130 may add intermediate parameters for a peripheral frequency of each frequency component and normalize the added value in an effort to calculate the speech absence probability of each frequency component. A method of calculating a speech absence probability is described with reference to FIG. 3.

The noise estimation unit 140 may estimate noise based on the speech absence probability. For example, the noise estimation unit 140 may discriminate a speech-dominant region or a noise-dominant region using the calculated speech absence probability, and may estimate noise based on the discrimination result. The noise estimation unit 140 may estimate noise by tracking local minima on a frequency axis in respect to the spectrum of a frame corresponding to the speech-dominant region.

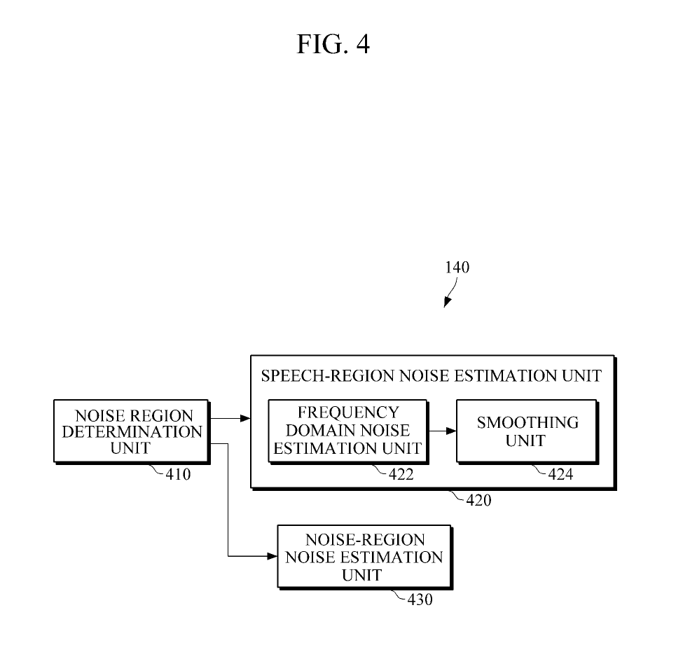

The noise estimation unit 140 may determine whether a target sound is present by comparing the calculated speech absence probability to a threshold value. For example, the threshold value may vary from 0 to 1, and may be experimentally set according to the purpose of use. During target sound detection, the threshold may vary with risk which may include false alarm and false rejection. The noise estimation is described with reference to FIG. 4.

The apparatus 100 for estimating noise may be implemented in a sound quality enhancing apparatus and may be used to enhance a sound quality of a target sound by further including a noise removal unit (not illustrated) that removes the noise estimated by the noise estimation unit 140 from an acoustic signal transformed in frequency domain.

FIG. 2 illustrates an example of a method for calculating a phase difference between acoustic signals. For example, the acoustic signals may be input from two microphones.

Referring to FIG. 2, two microphones reside a distance d apart from each other, the distance satisfies far-field conditions in which a distance from a sound source is relatively longer than a distance between the microphones, and the sound source is placed in a direction of θₜ. In this example, a first signal x₁(t, r) from the first microphone 10 and a second signal x₂(t, r) from the second microphone 20 which are input at time t in respect to the sound source present in an area r may be represented by Equations 3 and 4.

$$\begin{matrix}{x}_{1} ( t , r ) = A {e}^{j \{ ω t - \frac{2 π}{λ} co s {θ}_{τ} \cdot ( - \frac{d}{2} ) \}} & ( 3 ) \\ {x}_{2} ( t , r ) = A {e}^{j \{ ω t - \frac{2 π }{λ} co s {θ}_{τ} \cdot ( \frac{d}{2} ) \}} & ( 4 )\end{matrix}$$

In Equations 3 and 4, a value of r is spatial coordinates, θₜ represents a direction angle of a sound source, and λ represents a wavelength of the sound source.

A phase difference between the first signal x₁(t, r) and the second signal x₂(t, r) may be represented by Equation 5.

$$\begin{matrix}Δ P = ∠ {x}_{1} ( t , r ) - ∠ {x}_{2} ( t , r ) \\ = \frac{2 π}{λ} d cos {θ}_{t} \\ = \frac{2 π f}{c} d cos {θ}_{t}\end{matrix} \qquad ( 5 )$$

In Equation 5, c represents a speed (330 m/s) of sound wave and f represents frequency.

Thus, under the assumption that the direction angle of the sound source is θₜ, the phase difference of each frequency may be estimated using Equation 5. In respect to an acoustic signal that is input in a direction of θₜ with respect to a particular location, a phase difference ΔP may vary with frequency.

In this example, θ_{Δ} represents a predefined target sound allowable angle range (or allowable sound source direction range) that includes the direction angle θₜ of the target sound and may be set by taking influence of noise into consideration. For example, if a target sound direction angle θₜ is π/2, a direction range θ_{Δ} from 5π/12 to 7π/12 may be set as a target sound allowable angle range in consideration of the influence of noise.

The target sound phase difference allowable range may be calculated using Equation 5 based on the recognized target sound direction angle θₜ and the determined target sound allowable angle range θ_{Δ}.

FIG. 3 illustrates an example of a target sound phase difference allowable range according to a frequency detected.

FIG. 3 illustrates a graph of a phase difference ΔP of each frequency that is calculated under the assumption that the target sound directional angle θₜ is π/2 and a target sound allowable range θ_{Δ} is from about 5π/12 and 7π/12 in consideration of influence of noise. For example, if a phase difference ΔP calculated at 2000 Hz in a frame of an acoustic signal currently input is within about −0.1 to 0.1, the phase difference ΔP may be considered as falling within the target sound phase difference allowable range. As another example, referring to FIG. 3, the target sound phase difference allowable range may widen as frequency increases.

In consideration of relationship between the target sound allowable angle range and the target sound phase difference allowable range, if a phase difference ΔP of a specific frequency of a currently input acoustic signal is included in the target sound phase difference allowable range, a target sound may be determined as present. As another example, if the phase difference ΔP of the specific frequency is not included in the target sound phase difference allowable range, a target sound may be determined as absent.

In one example, an intermediate parameter may be calculated by applying a weight to a frequency component included in the target sound phase difference allowable range.

Theoretically, a phase difference indicates a direction in which sound of a frequency component is present at a given time. However, it may be difficult to accurately estimate the sound due to the ambient noise or circuit noise. In order to improve the accuracy of speech absence estimation, the speech absence probability calculation unit 130 as shown in the example illustrated in FIG. 1 may not estimate the speech absence probability directly from the phase difference, but may instead extract an intermediate parameter. For example, the intermediate parameter may be set to 1 when the phase difference is greater than a threshold value and may be set to 0 when the phase difference is smaller than the threshold value.

For example, the intermediate parameter F_{b}(m) may be defined using Equation 6 that is a binary function for determining the presence of a target sound.

$${F}_{b} ( m ) = \{ \begin{matrix}0 , & {TH}_{L} ( m ) < Δ P ( m ) < {Th}_{H} ( m ) \\ 1 , & otherwise\end{matrix} \qquad ( 6 )$$

In Equation 6, ΔP(m) represents a phase difference corresponding to the mth frequency of an input signal. In this example, Th_{L}(m) and Th_{H}(m) represent a low threshold and a high threshold, respectively, of a target sound phase difference allowable range corresponding to the mth frequency.

The low threshold value Th_{L}(m) and the high threshold value Th_{H}(m) of the target sound may be represented by Equation 7 and Equation 8, respectively.

$$\begin{matrix}{Th}_{H} ( m ) = \frac{2 π f}{c} d cos ( {θ}_{t} - \frac{{θ}_{Δ }}{2} ) & ( 7 ) \\ {Th}_{L} ( m ) = \frac{2 π f}{c} d cos ( {θ}_{t} + \frac{{θ}_{Δ }}{2} ) & ( 8 )\end{matrix}$$

The low threshold Th_{L}(m) and the high threshold value Th_{H}(m) of the target sound phase difference allowable range may be changed based on the target sound allowable angle range θ_{Δ}.

An approximate relationship between frequency f and a frequency index m may be represented by Equation 9 below.

$$f = \frac{m \cdot {f}_{s}}{{N}_{FFT}} \qquad ( 9 )$$

In Equation 9, N_{FFT} denotes an FFT sample size and fₛ denotes a sampling frequency. It should be appreciated that Equation 9 may be changed into a different form because it represents an approximate relationship between frequency f and a frequency index m.

The speech absence probability calculation unit 130 may add the intermediate parameters of peripheral frequency components of each frequency component, and may normalize the added value to calculate the speech absence probability of each frequency component. For example, if the added peripheral frequency components with respect to a current frequency component (k) is ±K, the speech absence probability P(k, t) may be calculated by Equation 10 based on an intermediate parameter F_{b}(k,t) at a frequency index k and at a time index t.

$$P ( k , t ) = \frac{1}{2 K + 1} {\sum }_{m = - K}^{K} {F}_{b } ( k + m , t ) \qquad ( 10 )$$

The noise estimation unit 140 may estimate noise of a current frame using the speech-absence probability, an acoustic signal at a current frame, and a noise estimation value at a previous frame. For example, the noise estimation unit 140 may perform the estimation differently between a speech-dominant signal region and a noise-dominant signal region. In a noise-dominant signal region, a target sound signal may be determined as being absent, and noise may be estimated from the spectrum of the input signal.

As another example, in a speech-dominant region, because both speech and noise are present, it may be difficult to detect only noise components. In previous researches, a gain that is obtained from a noise-dominant region is multiplied with the current spectrum in an effort to detect noise. However, because the spectrum of the noise-dominant region generally includes speech components, and because noise is estimated from the speech-dominant region using a gain that is obtained from the noise-dominant region, an error in estimating a frequency component of an actual speech spectrum as a noise component may occur.

FIG. 4 illustrates an example of the noise estimation unit shown in FIG. 1.

Referring to FIG. 4, the noise estimation unit 140 includes noise region determination unit 410, a speech-region noise estimation unit 420, and a noise-region noise estimation unit 430.

The noise region determination unit 410 may discriminate each region of an acoustic signal as a speech-dominant region or a noise-dominant region based on the calculated speech absence probability. The speech absence probability may be calculated at each time index in respect to the spectrum of input frame. The noise region determination unit 410 may determine a noise region as a region of an acoustic signal that has a speech absence probability greater than a threshold value, and may determine a speech-dominant region as a region other than the noise region.

The noise region determination unit 410 may control the speech-region noise estimation unit 420 to perform noise estimation in a speech-dominant region. As another example, the noise region determination unit 410 may control the noise-region noise estimation unit 430 to perform noise estimation in a noise region. It should be appreciated that the configuration of the noise region determination unit 410 to control the speech-region noise estimation unit 420 and the noise-region noise estimation unit 430 is only one example. For example, the noise region determination unit 410 may be substituted by a functional unit that discriminates a speech-dominant region.

In the example of FIG. 4, the speech-region noise estimation unit 420 includes a frequency domain noise estimation unit 422 and a smoothing unit 424.

For example, the frequency domain noise estimation unit 422 may track local minima on a frequency axis in respect to the spectrum of a current frame. The frequency domain noise estimation unit 422 may perform noise estimation based on the local minima in a frequency domain of each of the frames that are discriminated as speech-dominant regions.

Although local minima are generally tracked on a time axis, the frequency domain noise estimation unit 422 may track the local minima on a frequency axis. Accordingly, the noise that is estimated by the local minima on a frequency axis may be accurately tracked even if noise characteristics change over time in the speech-dominant region.

For example, if a time index is t, a frequency index is k, and the spectral magnitude of an input acoustic signal is Y(k,t), the frequency domain noise estimation unit 422 may determine is that the spectral magnitude Y(k,t) is highly likely to contain speech if the spectral magnitude Y(k,t) is greater than noise Λ(k−1,t) that is estimated by tracking local minima at a frequency index k−1. In this example, the frequency domain noise estimation unit 422 may allocate noise Λ(k,t) that is estimated by tracking local minima at a frequency index k, as a value between Λ(k−1,t) and Y(k,t).

Further, the frequency domain noise estimation unit 422 may allocate noise Λ(k,t) that is estimated by tracking local minima at a frequency index k between Λ(k−1,t) and Y(k,t) using Λ(k,t), Λ(k−1,t) and Y(k−1,t) to estimate the noise based on the local minima on the frequency axis. In this example, Y(k,t) represents a spectral magnitude of an input acoustic signal at a time index t and a frequency index k.

In addition, the frequency domain noise estimation unit 422 may allocate noise Λ(k,t) that is estimated by tracking local minima at the frequency index k as a value of the spectral magnitude Y(k,t) when the spectral magnitude Y(k,t) is not greater than the noise Λ(k−1,t) that is estimated by tracking local minima at the frequency index k−1, and thereby estimate the noise based on the local minima on the frequency axis.

This may be represented by Equation 11 below.

$$If Λ ( k - 1 , t ) < Y ( k , t ) , \\ Λ ( k , t ) = α Λ ( k - 1 , t ) + \frac{1 - α}{1 - β} \{ Y ( k , t ) - β Y ( k - 1 , t ) \} , \\ Otherwise , Λ ( k , t ) = Y ( k , t ) \qquad ( 11 )$$

In Equation 11, α and β represent adjustment factors that can be experimentally optimized.

The noise-region noise estimation unit 430 may estimate a noise spectrum based on an input spectrum in a noise-dominant region. For example, the noise-region noise estimation unit 430 may estimate noise using a spectral magnitude of the input signal that is obtained by a FFT transformation for a noise region that may be performed by the frequency transformation unit 110 (see FIG. 1).

However, because no linkage between the noise region and the speech-dominant region is present, inconsistency of the noise spectrum may occur unexpectedly in the boundary between the noise-dominant region and the speech-dominant region. To prevent an unexpected inconsistency of the noise spectrum in the boundary between the noise-dominant region and the speech-dominant region, the smoothing unit 424 may use the speech absence probability that is obtained by the speech absence probability calculated unit 130 shown in FIG. 1.

For example, the smoothing unit 424 may use noise \hat{Λ}(k, t−1) that has been estimated by tracking local minima and that has been smoothed using a speech absence probability at a previous time index t−1, noise Λ(k,t) that is tracked by local minima at a time index t, and the speech absence probability P(k,t) at a frequency index k and a time index t as a smoothing parameter for \hat{Λ}(k, t−1) and Λ(k,t). In this example, the smoothing unit 424 may determine smoothed noise \hat{Λ}(k, t) by smoothing the noise Λ(k,t) using the speech absence probability P(k,t), and may estimate the smoothed noise \hat{Λ}(k, t) as final noise. The final noise may be represented by Equation 12 below.

\hat{Λ}(k,t)=Λ(k,t)(1−P(k,t))+\hat{Λ}(k,t−1)P(k,t) (12)

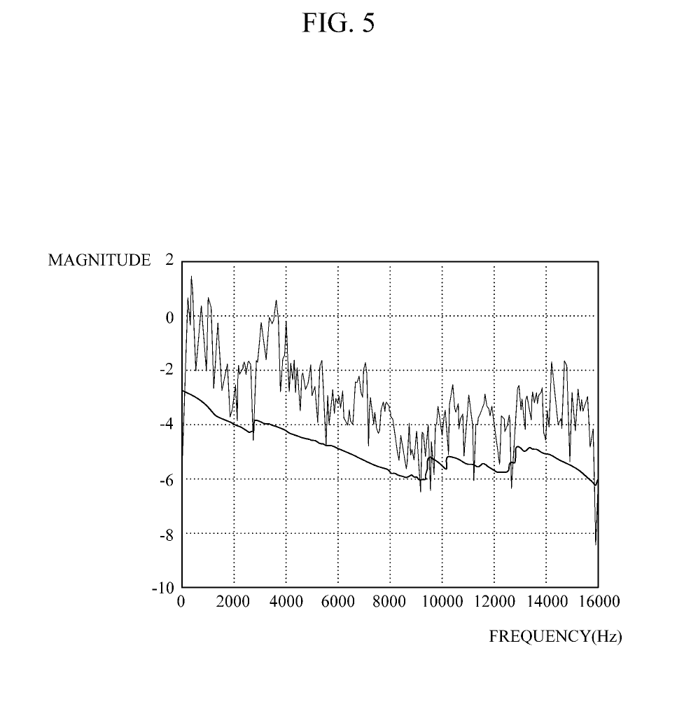

FIG. 5 illustrates an example of a noise level tracking result based on local minima in a speech-dominant region.

Referring to FIG. 5, noise can be tracked by local minima connected to each other on a frequency axis at a specific time. By removing noise using the tracked noise estimation result, a quality of an acoustic signal may be improved.

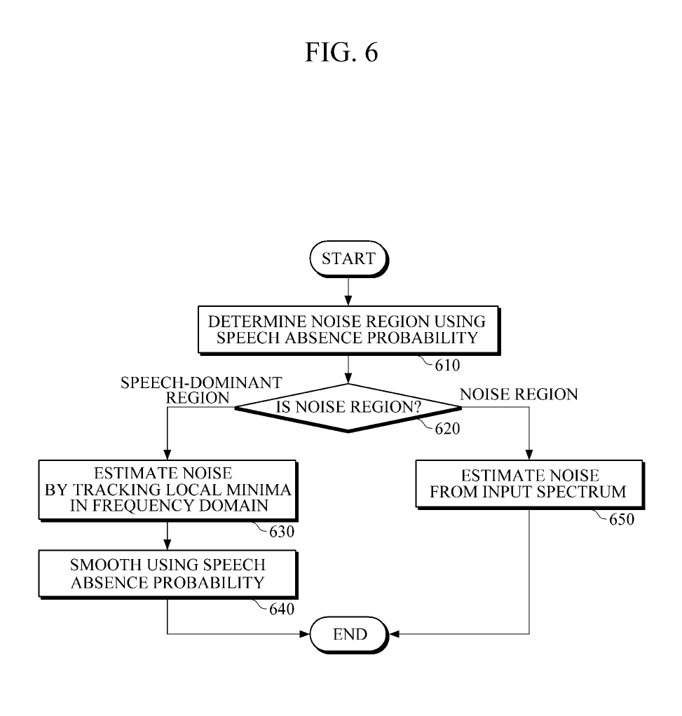

is FIG. 6 illustrates an example of a method for estimating noise according to discrimination of a speech-dominant region and a noise region.

Referring to FIG. 6, a region of an acoustic signal to be processed using a calculated speech absence probability is discriminated as a speech-dominant region or a noise region (610). For example, the noise estimation method may be determined according to a type of a region, including a noise-dominant region or a speech-dominant region. In (620) a determination is made as to whether the region is a noise region or a speech-dominant region.

If the region is determined as the speech-dominant region in 620, noise is estimated by tracking local minima on a frequency axis in respect to the spectrum of a frame corresponding to the speech-dominant region (630).

To prevent a sudden inconsistency of estimated noise in a boundary between the speech-dominant region and a noise-dominant region, noise estimated based on local minima using a speech absence probability is smoothed (640).

If the region is determined as a noise region in 620, noise is estimated from a spectral magnitude of the acoustic signal input in a noise dominant region (650).

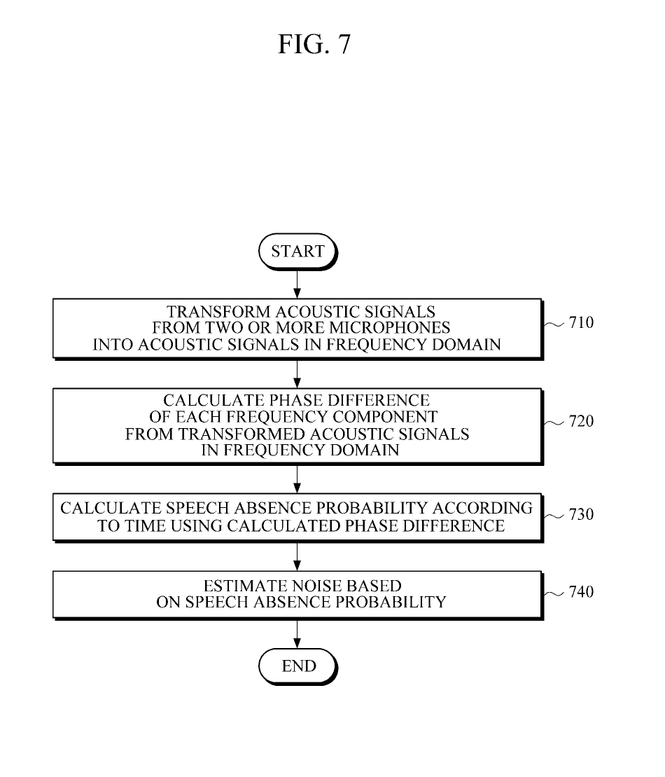

FIG. 7 illustrates an example of a method for estimating noise of an acoustic signal. For example, the acoustic signal may be input from a plurality of microphones.

Referring to FIG. 7, acoustic signals input by an acoustic signal input unit including two or more microphones are transformed into acoustics signals in a frequency domain (710).

A phase difference of each frequency component is calculated from the acoustic signals that have been transformed in a frequency domain (720).

A speech absence probability that speech is absent with respect to a frequency component according to noise time is calculated (730). For example, an intermediate parameter may be extracted. The intermediate parameter may indicate whether the phase difference for each frequency component is within a target sound phase difference allowable range determined based on a target sound direction angle. Based on the intermediate parameters extracted with respect to peripheral frequency components of each frequency component, the speech absence probability may be calculated in 730.

Based on the speech absence probability, a speech-dominant region and a noise region are discriminated from acoustic signals and noise is estimated from the discriminated region (740). For example, 740 may be performed as described with reference to FIG. 6.

According to various examples described herein, noise may be estimated from acoustic signals that are input from a plurality of microphones, and noise estimation may be performed in a speech-dominant area based on local minima on a frequency axis. To prevent an inconsistency of noise estimated between the speech-dominant region and the noise region, the noise estimation may be performed in the speech-dominant region using a speech absence probability, and thus the noise estimation result may be improved. Accordingly, a quality of a target sound may be enhanced by removing the noise that is accurately estimated.

Program instructions to perform a method described herein, or one or more operations thereof, may be recorded, stored, or fixed in one or more computer-readable storage media. The program instructions may be implemented by a computer. For example, the computer may cause a processor to execute the program instructions. The media may include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The program instructions, that is, software, may be distributed over network coupled computer systems so that the software is stored and executed in a distributed fashion. For example, the software and data may be stored by one or more computer readable storage mediums. Also, functional programs, codes, and code segments for accomplishing the example embodiments disclosed herein can be easily construed by programmers skilled in the art to which the embodiments pertain based on and using the flow diagrams and block diagrams of the figures and their corresponding descriptions as provided herein. Also, the described unit to perform an operation or a method may be hardware, software, or some combination of hardware and software. For example, the unit may be a software package running on a computer or the computer on which that software is running.

As a non-exhaustive illustration only, a terminal/portable device/communication unit described herein may refer to mobile devices such as a cellular phone, a personal digital assistant (PDA), a digital camera, a portable game console, and an MP3 player, a portable/personal multimedia player (PMP), a handheld e-book, a portable lab-top PC, a global positioning system (GPS) navigation, and devices such as a desktop PC, a high definition television (HDTV), an optical disc player, a setup box, and the like capable of wireless communication or network communication consistent with that disclosed herein.

A computing system or a computer may include a microprocessor that is electrically connected with a bus, a user interface, and a memory controller. It may further include a flash memory device. The flash memory device may store N-bit data via the memory controller. The N-bit data is processed or will be processed by the microprocessor and N may be 1 or an integer greater than 1. Where the computing system or computer is a mobile apparatus, a battery may be additionally provided to supply operation voltage of the computing system or computer. It will be apparent to those of ordinary skill in the art that the computing system or computer may further include an application chipset, a camera image processor (CIS), a mobile Dynamic Random Access Memory (DRAM), and the like. The memory controller and the flash memory device may constitute a solid state drive/disk (SSD) that uses a non-volatile memory to store data.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A noise estimation apparatus comprising:
an acoustic signal input unit comprising two or more microphones;
a frequency transformation unit configured to transform acoustic signals input from the acoustic signal input unit into acoustic signals in a frequency domain;
a phase difference calculation unit configured to calculate a phase difference of each frequency component from the transformed acoustic signals in the frequency domain;
a speech absence probability calculation unit configured to calculate a speech absence probability that indicates the possibility of the absence of speech in each frequency component according to time, using the calculated phase difference; and
a noise estimation unit configured to discriminate a speech-dominant region or a noise region from the acoustic signals, based on the speech absence probability, and to estimate noise according to the discrimination result.

2. The noise estimation apparatus of claim 1, wherein the speech absence probability calculation unit is further configured to extract an intermediate parameter that indicates whether the phase difference of each frequency component is within a target sound allowable range that is determined based on a target sound direction angle, and to calculate the speech absence probability of each frequency component using the intermediate parameter for peripheral frequency components of each frequency component.

3. The noise estimation apparatus of claim 2, wherein the speech absence probability calculation unit is configured to allocate the intermediate parameter as ‘0’ if the phase difference of each frequency component is within the target sound phase difference allowable range, and otherwise to allocate the intermediate parameter as ‘1.’

4. The noise estimation apparatus of claim 2, wherein the speech absence probability calculation unit is further configured to add intermediate parameters of peripheral frequency components of each frequency component, normalize the added values, and calculate the speech absence probability of each frequency component.

5. The noise estimation apparatus of claim 1, wherein the noise estimation unit is further configured to determine, with respect to the acoustic signals in a frequency domain, a region in which the calculated speech absence probability is greater than a threshold value as a noise region, and to determine a region in which the calculated speech absence probability is smaller than the threshold value as a speech-dominant region.

6. The noise estimation apparatus of claim 1, wherein the noise estimation unit is further configured to estimate noise by tracking local minima on a frequency axis with respect to spectrum of a frame of an acoustic signal that corresponds to the speech-dominant region.

7. The noise estimation apparatus of claim 6, wherein a time index is t, a frequency index is k, and a spectral magnitude of an input acoustic signal is Y(k,t), the noise estimation unit is further configured to track local minima on a frequency axis by determining that the spectral magnitude Y(k,t) is likely to contain speech and allocating noise Λ(k,t), which is estimated by tracking local minima at a frequency index k, as a value between Λ(k−1,t), which is estimated by tracking local minima at a frequency index k−1, and the spectral magnitude Y(k,t) when the spectral magnitude Y(k,t) is greater than noise Λ(k−1,t), and by allocating noise Λ(k,t) as a value of the spectral magnitude Y(k,t) when the spectral magnitude Y(k,t) is not greater than the noise Λ(k−1,t).

8. The noise estimation apparatus of claim 6, wherein the noise estimation unit is further configured to smooth the estimated noise using the calculated speech absence probability.

9. The noise estimation apparatus of claim 8, wherein the noise estimation unit is further configured to use noise \hat{Λ}(k, t−1) that has been estimated by tracking local minima and been smoothed using a speech absence probability at a previous time index t−1, noise Λ(k,t) that is tracked by local minima at a time index t, and the speech absence probability P(k,t) at a frequency index k and a time index t as a smoothing parameter for \hat{Λ}(k, t−1) and Λ(k, t), to determine smoothed noise \hat{Λ}(k, t) by smoothing the noise Λ(k,t) using the speech absence probability P(k,t), and to estimate the smoothed noise \hat{Λ}(k, t) as final noise.

10. The noise estimation apparatus of claim 1, wherein the noise estimation unit is further configured to estimate the noise from a spectral magnitude that results from transforming an acoustic signal in a frequency domain that is input in the noise region.

11. A noise estimation method comprising:
transforming acoustic signals input from two or more microphones into acoustic signals in a frequency domain;
calculating a phase difference of each frequency component from the transformed acoustic signals in a frequency domain;
calculating a speech absence probability that indicates the possibility of the absence of speech in each frequency component according to time based on the calculated phase difference; and
discriminating a speech-dominant region and a noise dominant region from the acoustic signals based on the speech absence probability and estimating noise based on the discrimination result.

12. The noise estimation method of claim 11, wherein the calculating of the speech absence probability comprises
extracting an intermediate parameter that indicates whether the phase difference of each frequency component is within a target sound allowable range that is determined based on a target sound direction angle, and
calculating the speech absence probability of each frequency component using the intermediate parameter for peripheral frequency components of each frequency component.

13. The noise estimation method of claim 12, wherein the extracting of the intermediate parameter comprises allocating the intermediate parameter as ‘0’ if the phase difference of each frequency component is within the target sound phase difference allowable range, and otherwise allocating the intermediate parameter as ‘1.’

14. The noise estimation method of claim 13, wherein the calculating of the speech absence probability using the extracted intermediate parameter comprises
adding intermediate parameters of peripheral frequency components of each frequency component, and
normalizing the added value to calculate a speech absence probability of each frequency component.

15. The noise estimation method of claim 11, wherein the estimating of the noise comprises determining, with respect to the acoustic signals in a frequency domain, a region in which the calculated speech absence probability is greater than a threshold value as a noise region, and determining a region in which the calculated speech absence probability is smaller than the threshold value as a speech-dominant region.

16. The noise estimation method of claim 11, wherein the estimating of the noise comprises
estimating noise by tracking local minima on a frequency axis with respect to spectrum of a frame of an acoustic signal which corresponds to the speech-dominant region, and
smoothing the estimated noise using the calculated speech absence probability.

17. The noise estimation method of claim 11, wherein the estimating of the noise comprises estimating the noise from a spectral magnitude which results from transforming an acoustic signal in a frequency domain that is input in the noise region.

18. A noise estimation apparatus for estimating noise in acoustic signals in a frequency domain, the noise estimation apparatus comprising:
a speech absence probability unit configured to calculate a speech absence probability indicating the probability that speech exists in each frame of an acoustic signal; and
a noise estimation unit configured to distinguish between a speech-dominant frame and a noise dominant frame based on the calculated speech absence probability, to estimate noise for a speech-dominant frame using a first method in the frequency domain, and to estimate noise for a noise-dominant frame using a second method in the frequency domain.

19. The noise estimation apparatus of claim 18, wherein the first method comprises estimating noise in the speech-dominant frame by tracking local minima on a frequency axis, and the second method comprises estimating noise in the noise-dominant frame using a spectral magnitude of the acoustic signal that is obtained by performing a Fourier transform on the acoustic signal.

20. The noise estimation apparatus of claim 19, wherein the first method further comprises smoothing noise that has been estimated by tracking local minima based on the calculated speech absence probability, to reduce the occurrence of inconsistency in a noise spectrum on the boundary between the noise-dominant region and the speech-dominant region.

21. The noise estimation apparatus of claim 18, further comprising a frequency transformation unit configured to transform a plurality of acoustic signals in a time domain, into a plurality of acoustic signals in the frequency domain; and
a phase difference calculation unit configured to calculate a phase difference of each frequency component from the transformed acoustic signals in a frequency domain.

22. The noise estimation apparatus of claim 21, wherein the speech absence probability unit calculates the speech absence probability based on a phase difference between the plurality of acoustic signals in the frequency domain.

23. The noise estimation apparatus of claim 21, wherein the speech absence probability unit calculates the speech absence probability based on an intermediate parameter that is set by comparing the phase difference of each frequency component to a threshold value.

24. The noise estimation apparatus of claim 18, further comprising a noise removal unit configured to remove the noise estimated by the noise estimation unit from the acoustic signal in the frequency domain.
